(19) United States
(12) Patent Application Publication
(10) Pub. No.: US 2008/0307036 A1
(43) Pub. Date: Dec. 11, 2008

(54) CENTRAL SERVICE ALLOCATION SYSTEM

(75) Inventors: Vishal Mishra, Sammamish, WA (US); Mark Michael Frabotta, Redmond, WA (US); Girish Nagaraja, Kirkland, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/759,543

(22) Filed: Jun. 7, 2007

(51) Int. Cl. G06F 15/16; G06F 17/30; G06F 7/00

(52) U.S. Cl. 709/203; 707/3; 707/E17.005; 707/E17.014

(57) ABSTRACT

The disclosure relates to a service allocation system in which servers advertise services they offer to the system and clients ask for services to consume. Both the clients and the servers interact with the allocation system using database calls to at least one of a plurality of databases. Servers that provide services update the current status of a service periodically. High-availability and load-balancing of the services can be achieved. The allocation system can be used for a single type of service or multiple different types of services.

### TECHNICAL FIELD

This disclosure is related to allocating servers that can perform a particular service to clients requesting those services.

### BACKGROUND

There is significant growth in the number of online services that a client application can utilize. In addition to web services, online services in recent years are able to provide additional computing resources on the fly, provide storage space, and audio/visual mixing. However, in any large-scale deployment of online services, servers dedicated to providing the online service must be matched in real-time to client applications currently requesting those services. The server applications have to come up with a way to advertise their current availability and constantly keep it up to date. At the same time, client applications need a way in real-time to allocate a service instance, in whole or in part, for their own use and subsequently get dependable access to the service. This allocation process needs to properly load balanced the servers providing the service in order to guarantee a high quality of service to the client applications. Additionally, the action of allocating a server should be such that even if a single server is available to take requests, the client is not denied access.

Traditionally, every service offered by the server and/or every client of that service has to develop their own solution to solve the real-time allocation problem, thereby resulting in extra network traffic, duplicate code to maintain, extra cost of development, testing, and system maintenance, and performance and collision issues.

The above-described deficiencies of current service allocation solutions are merely intended to provide an overview of some of the problems of today's service allocation techniques, and are not intended to be exhaustive. Other problems with the state of the art may become further apparent upon review of the description of various non-limiting embodiments of the invention that follows.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

According to one aspect of the invention, an allocation system uses multiple databases to store the current availability of servers to perform one or more services. Servers that provide one or more services notify at least one database upon startup of the one or more services (e.g., at server startup). Subsequently, the server periodically updates at least one database about the current availability of the service and optionally the current load of the machine. In response to a query from a client, at least one of the database servers responds with a server that is current available to provide an indicated service. The allocation system is decoupled from the underlying service and thus can be used by multiple types of services, including services offered by third-parties.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a schematic block diagram of an exemplary computing environment.

FIG. 2 depicts a block diagram of exemplary components of an allocation system according to one embodiment.

FIG. 3 illustrates interactions between the various components of the allocation system according to one embodiment.

FIG. 4 depicts exemplary columns of a database table used by the allocation system according to one embodiment.

FIG. 5 is a block diagram of exemplary components of a service server according to one embodiment.

FIG. 6 depicts an exemplary flow chart of the allocation system in processing allocation and service registration requests.

FIG. 7 is an exemplary flow chart of a service server publishing its availability to the allocation system and processing service requests.

FIG. 8 is an exemplary flow chart of a service client requesting allocation of a server that performs an indicated service and subsequent use of the allocated service.

FIG. 9 illustrates a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the word “service” refers to remotely invocable software or hardware functionality. Examples of a “service” include, but are not limited to, web services, DCOM components, Java RMI objects, COBRA objects, multimedia services (e.g. recording services), storage services, and grid computing services. Although the allocation system is agnostic to the specific type of service provided by the servers, the allocation system can be particular suitable for services that: require significant computational and/or network resources, such as media stream recording or mixing (e.g., recording a live event, or mixing a live broadcast); and/or take a long period of time to complete, such as services that help solve complex mathematical or scientific problems.

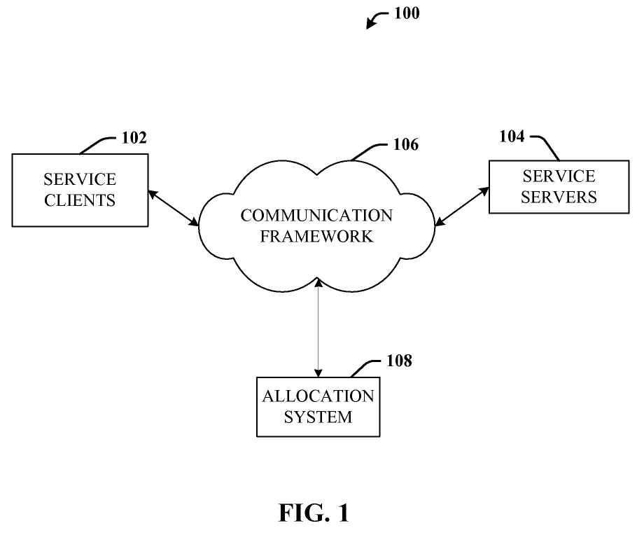

Referring now to FIG. 1, there is illustrated a schematic block diagram of an exemplary computing environment in which the allocation system is used. For the sake of simplicity, only a single machine of each type is illustrated, but one skilled in the art will appreciate that there can be (and usually are) multiple machines of any given type and that some of the types may have their functionality distributed between various computers. For example, in at least one embodiment, the service servers 104 are located in a server farm of servers that provide one or more services. The system 100 includes service clients 102, service servers 104, a communication framework 106, and an allocation system 108. The service client(s) 102 can be hardware and/or software (e.g., threads, processes, computing devices). The service client(s) use one or more services from the service servers 104. In order to use the services, a service client 102 uses the allocation system 108 to receive an indication of one or more service servers that can currently provide a requested service. In response, the service client 102, receives details, such as hostname, port, and URL, about a service server 104 that can currently provide the indicated service.

The system 100 also includes one or more service server(s) 104. The service server(s) 104 can also be hardware and/or software (e.g. threads, processes, computing devices). The service server provides one or more services to the service client. One possible communication between a service client 102 and a service server 104 can be in the form of data packets adapted to be transmitted between two or more computers. The data packets can include a request to invoke a service and a response from the service back to the service client.

The system 100 also includes an allocation server 108. The allocation server 108 can also be hardware and/or software (e.g., threads, processes, computing devices). The allocation server 108 receives communications via the communication framework 106 from the service server 104 and the service client 102. One possible communication from the service client 102 can be in the form of data packets transmitted between the systems. The data stream can be a database call, such as a standard SQL SELECT statement or a stored procedure call. Similarly, one possible communication from the service server 104 can also be in the form of a database call, such as a standard SQL statement (e.g., SELECT, UPDATE, INSERT) or a stored procedure call. Interaction may be performed in other manners such as web service calls in other embodiments. In addition to notification about the current availability of one or more services, database calls may be performed to perform various maintenance and housekeeping functions, such as to change the current state of a service instance running on the service server.

The system 100 includes a communication framework 106 (e.g., a global communication network such as the Internet, or an enterprise intranet) that can be employed to facilitate communications between the service client 102, service server 104, and allocation server 108. Communications can be facilitated via a wired (including optical fiber) and/or wireless technology.

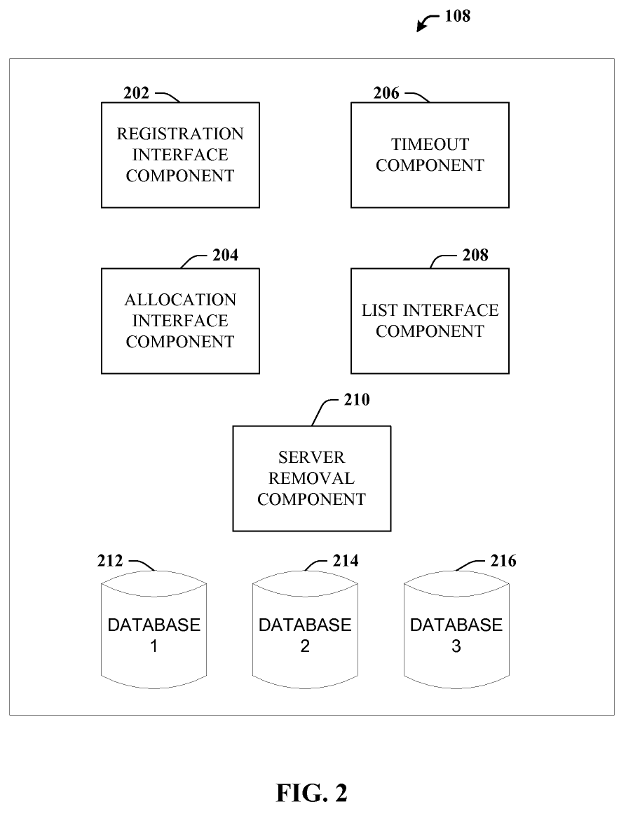

Referring to FIG. 2, FIG. 2 illustrates exemplary components of the allocation server 108 according to one embodiment. For the sake of clarity, only a single component of a particular type is illustrated; however, one will appreciate that there can be multiple components of the same type, such as one component for each of the databases of the allocation server 108. In addition, one will appreciate the functionality performed by the illustrated components may be organized into more or fewer components.

The illustrated allocation server 108 includes a registration interface component 202, an allocation interface component 204, a timeout component 206, a list interface component 208, a server removal component 210, and a plurality of databases (212, 214, and 216).

In at least one embodiment, the plurality of databases (212, 214, and 216) are separate from one another and each database maintains its own instance of the illustrated components. As a result, the service server makes database calls to each database in the plurality. While this adds complexity to the system, higher reliability is obtained as each database is independent (and can contain different data) and failure of one does not affect the other databases. When the databases are separated from one another, the service client can call other databases if a response of a server that provides an indicated service is not received, whether by failure of the database server to respond or the failure to locate a server that can currently provide the indicated service. In other embodiments, a database call can be made only to a single database and either the components or the nature of the database relationship (e.g., master/slave relationship) facilitates the other databases knowing of the update. As used herein, both arrangements of the databases are meant when the service server is described as interacting with at least one database of the plurality, unless it is clear from the context that the service server interacts with only a single database of the plurality.

One will appreciate that although three databases are illustrated, more or fewer databases may be used in other embodiments. Furthermore, although the database described below is a relational database (e.g., Oracle or SQL Server, PostgreSQL), other types of databases can be utilized alternatively, such as an XML database or an object-relational database.

The registration interface component 202 receives notifications from each of multiple service servers of a current availability of providing one or more services and stores the current availability in at least one of the plurality of databases. The registration interface component 202 can be implemented in one embodiment as a stored procedure in the database.

The allocation interface component 204 receives requests from service clients to locate a server that can currently provide an indicated service and queries at least one of the plurality of databases to find a server that can currently provide the indicated service. If more than one server can currently provide the indicated service, the allocation interface component determines the server to report to the client, for example, based on the current load, if known, of each of the servers that can currently provide the indicated service. After determining a server that can currently provide the indicated server, the allocation interface component indicates the server that can currently provide the indicated service. The allocation interface component 204 can be implemented in one embodiment as a stored procedure in the database.

The timeout component 206 interacts with the plurality of databases to indicate a non-current availability of a server to provide a service after a predetermined time (“shelf life”) of not receiving a notification from the server about the availability of the service. The list interface component 208 lists all servers that meet an indicated criteria. The indicated criteria can include all servers of a given type or sub-type, all servers not currently available, those servers that didn't update their availability status recently, etc. This list may be used by a server farm administrator to determine which service server to perform maintenance on. The server removal component 210 removes the row from the table in the database after it is no longer current available for a predetermined period of time, such as 3 days. These components (206, 208, 210) can be implemented in some embodiments as stored procedures.

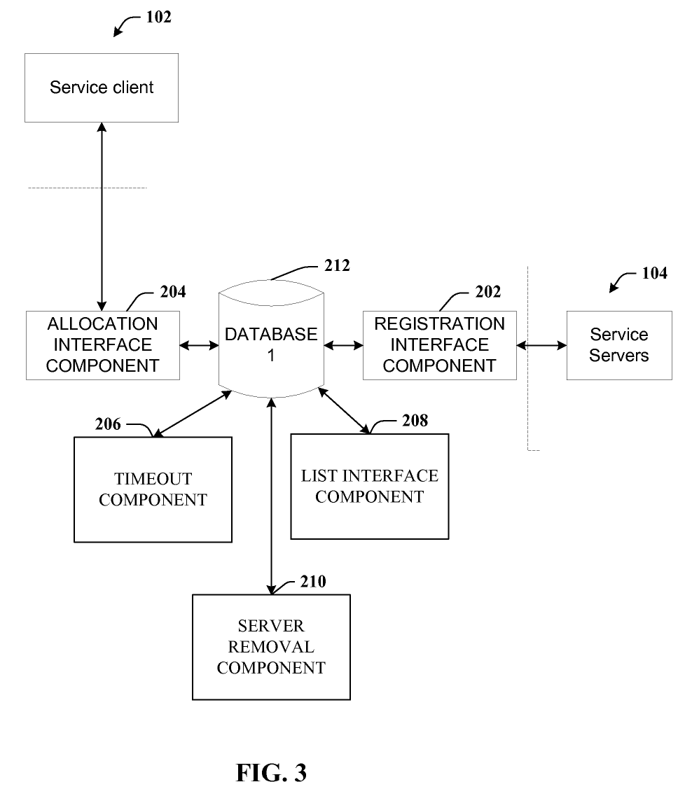

Referring to FIG. 3, FIG. 3 illustrates examples of various interactions with the allocation system and its internal components according to one embodiment. For the sake of clarity, interactions with a single database are illustrated. In particular, the service servers 104 interact with the registration interface component 202. Initial registration occurs upon startup of the service server and/or startup of a service (e.g., if the server sometimes offers another service). Data about the status of a service available via the server is given a shelf life. The shelf life can be preset by the allocation system (e.g., 10 seconds) or set by the service server upon initial registration. The shelf life in some embodiments can be constrained to a range, such as less than three minutes. If an update is not received in the specified shelf life, the service is assumed to be unavailable and as result will not be allocated to any clients. The timeout component 206 interacts with the database to set an appropriate flag when the shelf life is exceeded.

After initial registration, periodic notifications are sent to the registration interface component 202 to update the current availability of a service on the service server and the current load of the server. The period of the notification is less than the shelf life. For example, if the service server interacts with all databases in the plurality, the period of notification is less than 1/N, where N is the number of databases in the plurality. In order to facilitate the periodic notifications, in some embodiments database connection and or component connection caching is utilized as well as a notification timeout. A notification timeout can be utilized to make sure other servers receive a notification of the current status within the shelf life even if the notification to one database is not possible.

As a result of the periodic notifications, a database can be quickly rebuilt within the shelf life time on another database machine if one of the databases fails. In addition, the database maintains relatively current information on which to base allocations.

A service client 102 interacts with the allocation system via the allocation interface component. The client uses the allocation interface component to identify a server that can currently provide an indicated service to the client. The allocation interface queries the database 212 for a server that can currently provide the indicated service and has a reasonable load. If the exact load of the servers is known in the database 212, the service that can currently provide the service and has the lowest load can be allocated. In response the client receives an indication of a server that can currently provide the service. The indication can include the URL of the service, host name, IP address, and port. An authentication token can also be returned that, if supplied, is used when invoking the service on the indicated server.

The server removal component 210 interacts with the database to remove services from the database in which the services shelf life has been exceeded and remain for a predetermined period of time, such as three days. The list component 208 also interacts with the database to query the database for the indicated criteria. The indicated criteria may be specified by an administrator computer (not shown), the service client 102 or the service server 104.

Other interaction not shown can also be performed in some embodiments, such as explicitly indicating that a service is suspended.

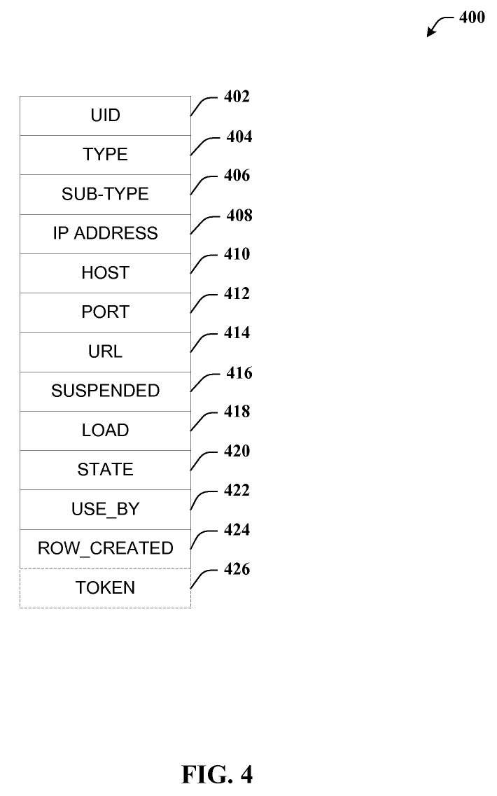

Referring to FIG. 4, an example block diagram of columns of a database table according to one embodiment is illustrated. The illustrated table includes columns: UID 402, Type 404, Sub-type 406, IP_Address 408, host 410, port 412, URL 414, suspended 416, load 418, state 420, use by 422, row created 424, and optionally token 426. The UID 402 is a unique identifier, such as a GUID, of an instance of a service on a server and it can be used as a primary key. The Type 404 and sub-type 406 indicates the type of service. A single service type may have a sub-type in at least some embodiments. For example, if a generic media stream mixing service is used, there may be various sub-types for each media stream type. The IP_Address 408, host 410, port 412, and the URL 414 provide the information necessary for a client to use this particular instance of the service. In some embodiments, a combination of these attributes can be used as a primary key and/or index.

The suspended 416 attribute indicates whether the service is temporarily suspended. The service is suspended if the service is not currently available or assumed not available. This attribute can be set automatically by the allocation system to suspended if a heartbeat is not received within the specified shelf life of the row. In addition, the attribute can be set by the service server as well. The Load 418 attribute indicates the current load on the server and/or of the particular service instance. In one embodiment, the load attribute can be a binary bit indicating normal status or overloaded status; however, in other embodiments, the load is a number indicating the actual load on the server and/or service. Information from the load 418 attribute can be used to decide which service instance to allocate to the client.

The state 420 attribute can be used more detailed state information than suspended and this attribute is set by the service server. The use_by 422 attribute and the row_created 424 attribute are used to determine if an entry in the database is stale. The two attributes are both timestamps. Row_created is a timestamp of the last time data in the row was last updated by the service server. The use_by timestamp indicates when the In some embodiments, one or more servers may use an authentication token 426 for additional security, such as to make sure a service client does not bypass the allocation system and use the same server all the time regardless of load.

One will appreciate that alternative embodiments may have additional or fewer columns and that the table may be split into two or more tables in other embodiments. For example, if the allocation system only allocates client for one type of service, then the type and sub-type fields can be dropped from the table in that embodiment. In addition, as previously mentioned, in other embodiments, databases other than a relational database can be used, such as an XML database or an object-relational database.

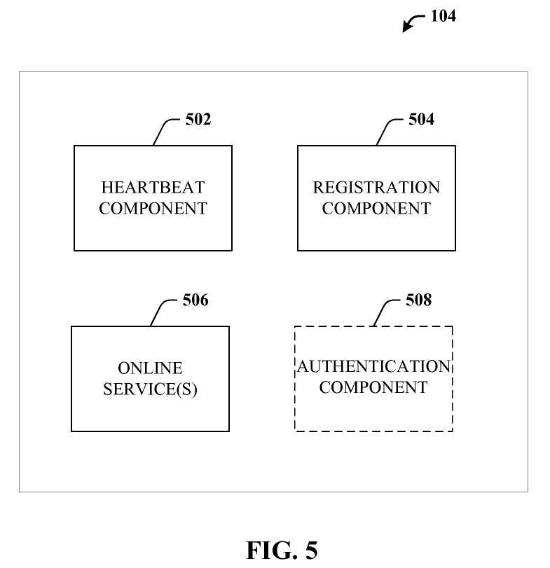

Referring to FIG. 5, a block diagram of components of a service server 104 is depicted. The components include a heartbeat component 502, a registration component 504, online service(s) 506, and optionally an authentication component 508. The heartbeat component 502 is configured to periodically notify at least one of the databases of the current availability of the one or more online services. In addition, the heartbeat can also report the current load of the machine. In some embodiments, the heartbeat component 502 caches the connection to the at least one database to make the periodic notifications faster. The registration component 504 is configured to initially register the one or more service at startup and deregister the services at shutdown. The registration component 504 can also be configured to read a configuration file to determine database servers to contact. In those embodiments where the service server take care of notifications to clients when deregistering a service, the registration component can also send the client notifications. Online services 506 perform the functionality of the one or more services made available to the service client.

In some embodiments, an authentication component 508 generates an authentication token to supply to the databases of the allocation system and verifies the authentication token when a client invokes an online service. The authentication token is a secret and can change frequently (e.g., every time the server is rebooted, after a predetermined period of time). The authentication token can prevent service clients from bypassing the allocation system.

As with the components of the allocation system, one will appreciate that the components of the service server may be distributed into more components or less components in other embodiments. Furthermore, additional or less functionality can be performed by any of the exemplary components in other embodiments.

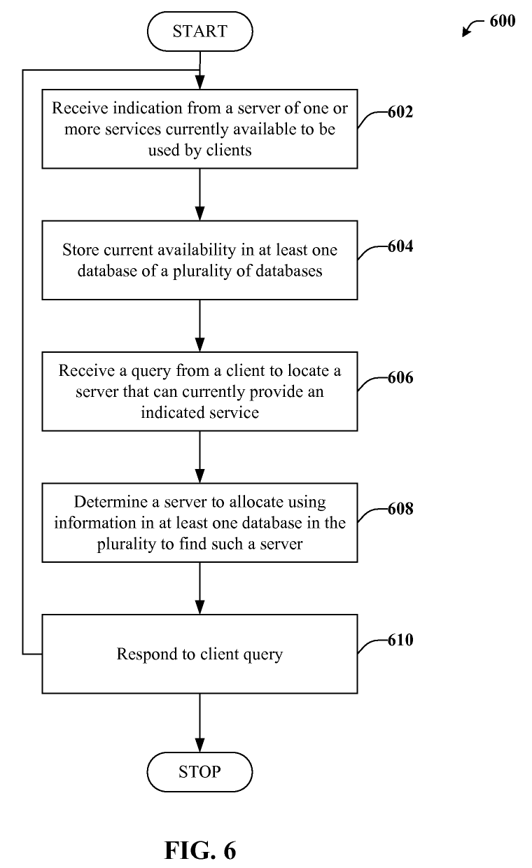

FIGS. 6-8 illustrate various methodologies in accordance with one embodiment. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media. Furthermore, it should be appreciated that although for the sake of simplicity an exemplary method is shown for use on behalf of a single user, the method may be performed for multiple users.

Referring now to FIG. 6, an exemplary method 600 of the allocation system in processing allocation and service registration requests is depicted. At 602, an indication is received from a server of one or more services current available to be used by clients. This indication may be initial indication or a heartbeat update of the current availability status of the services running on the service server. At 604, the current availability of the one more services is stored in at least one database of the plurality of databases. At 606, a query is received from a client to locate a server that can currently provide an indicated service. At 608, information in at least one database is used to find a server that can currently provide the service. At 610, a response is generated to the clients query and provided to the client.

Although not shown, as discussed above, the allocation system also performs various maintenance and housekeeping operations. For example, the allocation system changes the state of a service to not available after the shelf life of the current availability status has been reached. After a longer period of time (e.g., 3 days), the service may be removed from the database entirely. In addition, the allocation may handles various database operations, such as allowing the service server to explicitly indicate that a service is no longer currently available (e.g., suspended) or to list all other servers that can currently perform a particular service.

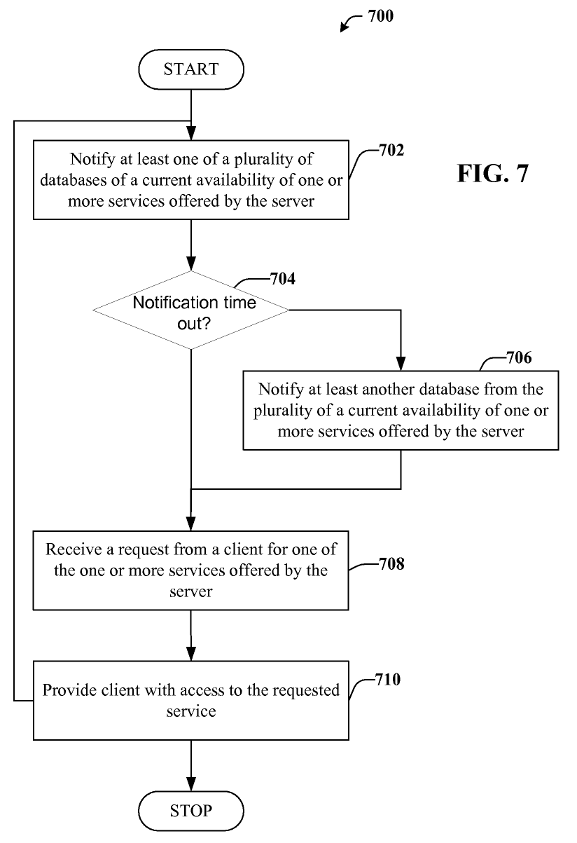

Referring now to FIG. 7, an exemplary method 700 is depicted of a service server publishing its availability to the allocation system and processing service requests from clients. At 702, the service server notifies at least one of a plurality of databases of one or more services offered by the server. At 704, it is determined if the notification timed out. If so, at 706, at least another database from the plurality is notified of the one or more services offered by the server. If not or after 706, at 708, a request is received from a client for one of the one or more services currently available from the server. At 710, the client is provided with access to the requested service.

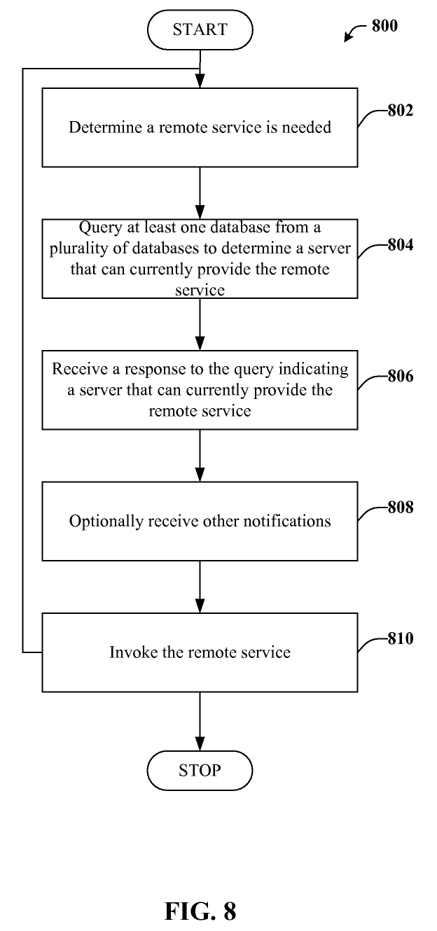

Referring now to FIG. 8, an exemplary method 800 is depicted of a service client requesting allocation of a server that performs an indicated service and subsequent use of the allocated service. At 802, the client determines that a remote service is needed, such as when a service is invoked by a client application. At 804, at least one database from a plurality of databases is queried to determine a server that can currently provide the remote service. In some embodiments, if a query from a first database does not return a server that can provide the service, another database from the plurality is tried until a response returns a server that can currently provide the service or all the databases in the plurality have been queried. At 806, a response to the query is received indicating a server that can currently provide the remote service. At 808, additional notifications can be optionally received by the service client. In one embodiment, the additional notification is an authentication token that is used to authenticate the client request when it is received by the service as part of invoking the service. In other embodiments, the additional notifications can include an indication that the service is no longer available from the server (e.g., the server is shutting down, or the services is temporarily suspended). At 810, the service is invoked on the server that has been returned by the database.

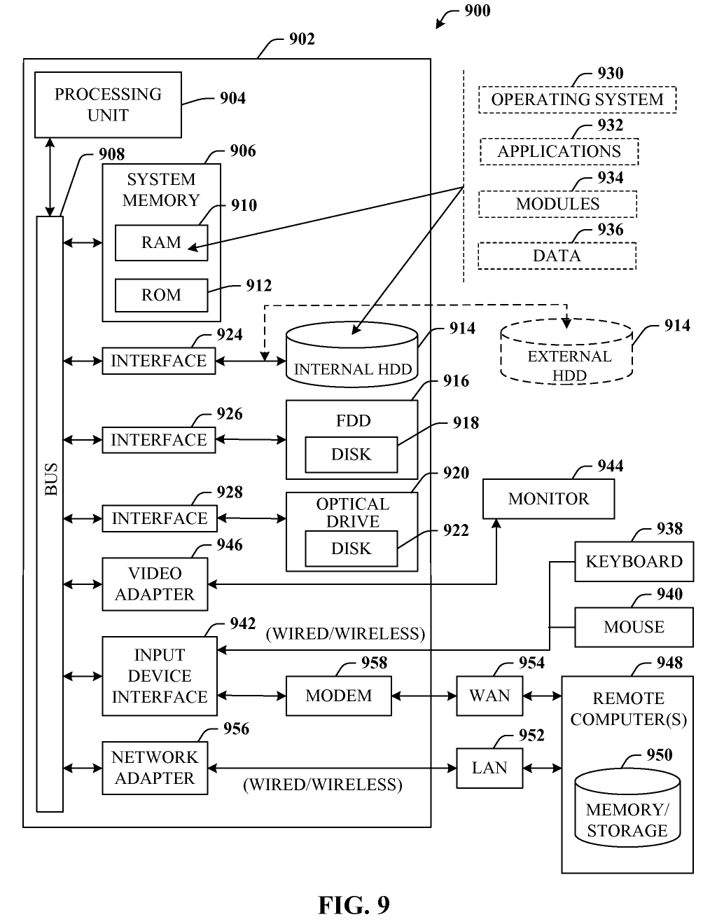

Referring now to FIG. 9, there is illustrated a block diagram of an exemplary computer system operable to execute one or more components of the disclosed allocation system. In order to provide additional context for various aspects of the subject invention, FIG. 9 and the following discussion are intended to provide a brief, general description of a suitable computing environment 900 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention can be practiced in distributed computing environments where certain tasks are performed by remote processing devices that are linked through a communications network. In at least one embodiment, a distributed computing environment is used for the allocation system in order to insure high-availability, even in the face of a failure of one or more computers executing parts of the allocation system. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the invention includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies. Other external drive connection technologies are within contemplation of the subject invention.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a remote computers, such as a remote computer(s) 948. The remote computer(s) 948 can be a workstation, a server computer, a router, a personal computer, portable computer, microprocessor-based entertainment appliance, a peer device or other common network node, various media gateways and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A service allocation system comprising:
a plurality of databases;
a registration interface component that receives notifications from each of multiple servers of a current availability of providing one or more services to a client and store the current availability in at least one of the plurality of databases; and
an allocation interface component that:
receives requests from multiple clients that each request a server that can currently provide an indicated service;
queries at least one of the plurality of databases to find a server that can currently provide the indicated service; and
indicates the server that currently provide the indicated service.

2. The system of claim 1, wherein the registration interface component and the allocation interface component are stored procedures in at least one of the plurality of databases.

3. The system of claim 1, wherein the registration interface component receives notifications from at least one of the multiple servers of a current availability of providing two or more distinct services to a client.

4. The system of claim 1, further comprising a list interface component that lists all servers that meet an indicated criteria.

5. The system of claim 1, further comprising a timeout component that interacts with the plurality of databases to indicate a non-current availability of a server to provide a service after a predetermined time of not receiving a notification from the server about the availability of the service.

6. The system of claim 1, wherein each database from the plurality has an allocation interface component and a registration interface component.

7. The system of claim 1, wherein each database is a relational database.

8. The system of claim 1, wherein the registration interface component receives notifications from each of multiple third-party servers of a current availability of providing one or more services to a third-party client.

9. A method on a server offering at least one service comprising:
notifying at least one of a plurality of databases of a current availability of a first service offered by the server;
receiving a request from each of one or more clients for the first service, each client previous interacting with at least one of the plurality of databases to discover the current availability of the first service; and
providing the first service to each of the one or more clients requesting the service.

10. The method of claim 9, further comprising:
notifying at least one of a plurality of databases of a current availability of a second service offered by the server, the second service different from the first service;
receiving a request from each of one or more clients for the second service, each client previous interacting with at least one of the plurality of databases to discover the current availability of the second service; and
providing the second service to each of the one or more clients requesting the service.

11. The method of claim 9 wherein the notifying of at least one of a plurality of databases of a current availability of a first service offered by the server includes notifying each of the plurality of databases of the current availability of the first service offered by the server.

12. The method of claim 9 wherein the notifying of at least one of a plurality of databases of a current availability of a first service offered by the server includes notifying another one of the plurality of databases of the current availability if the notification takes longer than a predetermined amount of time.

13. The method of claim 9 wherein the notifying of at least one of a plurality of databases of a current availability of a first service offered by the server includes invoking a stored procedure in each of the at least one of the plurality of databases.

14. The method of claim 9 wherein the notifying of at least one of a plurality of databases of a current availability of a first service offered by the server includes periodically renotifying at least one of the plurality of databases of a current availability of the first service offered by the server.

15. A computer-readable medium having computer-executable instructions for performing the method of claim 9.

16. A method comprising:
determining a first remote service is needed;
querying at least one of a plurality of databases to determine a server that can currently provide the first remote service;
receiving a response from at least one database of the plurality indicating a server that can currently provide the first remote service; and
invoking the first remote service on the indicated server.

17. The method of claim 16, further comprising:
determining a second remote service is needed, the second remote service different than the first remote service;
querying at least one of a plurality of databases to determine a server that can currently provide the second remote service;
receiving a response from at least one database of the plurality indicating a server that can currently provide the second remote service; and
invoking the second remote service on the indicated server

18. The method of claim 16, wherein the querying of at least one of a plurality of databases to determine a server that can currently provide the first remote service includes querying a second database from the plurality of databases to find a server that can currently provide the first remote service if querying of a first database did not return a response indicating that a server is currently able to provide the first remote service.

19. The method of claim 16, wherein the receiving of a response from at least one database of the plurality indicating a server that can currently provide the first remote service includes a token, and wherein the invoking of the first remote service on the indicated server includes supplying the token to authenticate the request.

20. A computer-readable medium having computer-executable instructions for performing the method of claim 16.
